(19) United States
(12) Patent Application Publication
(10) Pub. No.: US 2020/0009667 A1
(43) Pub. Date: Jan. 9, 2020

(54) Separator Unit Particularly Suitable for Being Used in Cutting Lines of Laminar Material into Strips and Cutting Line Comprising said Separator Unit

(71) Applicant: KEMA S.R.L. - IN LIQUIDAZIONE, Brendola (VI) (IT)

(72) Inventor: Andrea PILOT, Vicenza (IT)

(73) Assignee: Kema r.r.l. - In LiquidAzione, Brendola (VI) (IT)

(21) Appl. No.: 16/488,831

(22) PCT Filed: Feb. 27, 2018
(86) PCT No.: PCT/IB2018/051238

§ 371 Date: Aug. 26, 2019

(30) Foreign Application Priority Data
Feb. 27, 2017 (IT) 102017000021733

(51) Int. Cl. B23D 35/00; B26D 1/24

(52) U.S. Cl. CPC B23D 35/007; B26D 7/2621; B26D 1/245

(57) ABSTRACT

A separator unit suitable for being used in a cutting line of laminar materials into strips, of the type comprising an expandable shaft, a storage magazine for storing separator tools, which is operatively associated with an end of the expandable shaft, separator tools provided with ring nuts configured to allow the translation of the separator tools from the storage magazine to the expandable shaft, and vice versa, the separator tools being susceptible to being locked on the expandable shaft, and translation apparatus means configured to translate the separator tools along the expandable shaft. The separator unit provides for the expandable shaft to be provided with a first slit adapted to house a locking element with a knurling on its outwards facing surface and susceptible to translating in radial direction and provides for the ring nuts to have a counter-knurling on a length of their surfaces facing the expandable shaft. The knurling and the counter-knurling are configured to fixedly couple when the surface of the locking element is placed in contact with the surfaces of the ring nuts.

### BACKGROUND OF THE INVENTION

### 1. The Field of the Invention

The invention relates to an improved separator unit particularly suitable for being used in cutting lines of laminar materials into strips, wound on bobbins, in particular of sheets of different thicknesses, widths and lengths.

The invention also relates to the cutting line comprising one or more of the aforesaid separator units.

Furthermore, the invention relates to the method of arranging and locking separator tools along an expandable shaft belonging to the aforesaid separator unit.

### 2. The Relevant Technology

It is known that cutting lines allow obtaining strips of specific widths starting from a laminar material of greater width. In particular, to obtain such strips, it is known that the cutting lines provide shears comprising a pair of rotating shafts with parallel overlapping axes, between which the aforesaid laminar material is caused to pass.

More specifically, passing through such rotating shafts, the laminar material is cut into strips by annular blades and counter-blades mounted along the shafts by superimposing the cutting wire.

Downstream of such shears therefore is a plurality of strips which are to be simultaneously wound onto one or more winding bobbins arranged at the end of the cutting line.

To ensure that the plurality of such strips is wound adequately and simultaneously onto the aforesaid winding bobbins, the need is known to interpose some guide devices capable of allowing the sliding—to the greatest extent possible, the parallel sliding—of the strips along the cutting line, between the shears and the winding bobbins.

In particular, there are provided one or more separator units between the aforesaid notoriously used guide devices, the separator units comprising a rotating or non-rotating shaft on which separator tools, preferably discs having limited thickness, are positioned opportunely spaced apart from one another.

More specifically, each pair of such adjacent separator tools is arranged at a mutual distance that substantially is equal to the width of the strip that is to pass through it so as to prevent the lateral movement thereof and therefore ensure the parallel sliding of the aforesaid plurality of strips up to the winding bobbins.

Obviously, the mutual distance of each pair of separator tools varies according to the width of the strip that is to pass through them.

Therefore, it is known that the aforesaid separator tools are not fixedly coupled to the shaft, rather are susceptible to being axially translated along the shaft and once arranged at a predefined position, they are susceptible to being locked on it.

It is also known that a first type of separator units provides for the arrangement of the aforesaid separator tools along the shaft to be manually executed.

It is apparent that such manual arrangement disadvantageously requires an increased quantity of time to be executed. Moreover, a further drawback due to the aforesaid manual method consists of the increased possibility of positioning the separator tools in an inaccurate manner.

Alternatively, more evolved separator units are known that provide an automatic system for arranging the aforesaid separator tools along the shaft. In particular, there are known translation means arranged side-by-side the shaft and capable of being moved along a sliding axis parallel to the axis of the shaft. Such translation means are capable of hooking one or more of the separator tools from a storage magazine, usually operatively associated with an end of the shaft, and translating the tools along the latter at a preset position.

However, such solution of the prior art has the drawback that the volume occupied by the separator unit is greater than the manual type separator units, due precisely to the presence of the aforesaid translation means in addition to the shaft.

A further solution of the prior art provides for the aforesaid translation means to be integrated in the shaft and to comprise a retractable punch susceptible to axially translating along the shaft.

In particular, the retractable punch is caused to come out of the outer surface of the shaft at a separator tool in the magazine so as to hook the tool provided with a suitable housing and translate it along the shaft up to reaching its predefined position. Once arranged at such position, the punch is retracted so as to disassociate it from the housing of the tool, ready to hook a further tool.

To avoid the separator tools from inclining with respect to the position orthogonal to the axis of the shaft during translation and accordingly jamming on it, the tools have, at least at the sliding ring nut, a sufficient width to prevent any movement thereof other than the axial translation movement.

However, the aforesaid solution causes the drawback of the minimum distance for arranging two adjacent separator tools being limited by the width of the aforesaid ring nuts.

Thus, such separator tools, and accordingly the separator units comprising them, disadvantageously are not suitable for being used to guide strips having smaller sizes than the aforesaid minimum distance between two adjacent separator tools.

The use of expandable shafts is known with regard to the means and method for locking the aforesaid separator tools on the shaft.

In particular, such expandable shafts comprise expandable means arranged in substantially longitudinal direction, possibly in specific longitudinal housings in the shaft, the expandable means preferably comprising longitudinal strips with a vulcanized rubber finishing defined on the surface thereof facing outwards, and air chambers arranged between the strips and the shaft. Such expandable means are therefore susceptible to varying their volume by blowing a fluid, preferably a gas, even more preferably air, into the aforesaid air chambers.

For such purpose, the air chambers with substantially longitudinal development in most cases are operatively communicating with a pneumatic source configured to fill the air chambers and, alternatively, to allow the emptying thereof.

In other words, when the separator tools are positioned in the corresponding predefined positions, such expandable means are expanded based on the production specifications and accordingly the separator tools are locked on the shaft.

However, such locking means and the relative method are not capable of ensuring an optimal locking, especially in axial direction, of the aforesaid separator tools on the shaft when the latter are subjected to a lateral thrust greater than a given value.

Such situation essentially occurs when the strips passing through the separator unit have a given thickness and knocking laterally against the separator tools, impress on the latter such thrust which is greater than the aforesaid value.

Accordingly, this disadvantageously causes an undesired modification of the arrangement of the separator unit with a subsequent worsening of the guiding conditions of the strips through the separator unit.

### SUMMARY OF THE INVENTION

The present invention intends overcoming all the drawbacks mentioned.

In particular, it is the object of the invention to make a separator unit which, once provided, is capable of ensuring increased stability of its composition with respect to the separator units of the prior art.

In greater detail, it is the object of the invention to make a separator unit capable of improving locking the separator tools on the expandable shaft.

It is a further object of the invention to make a separator unit capable of keeping the aforesaid separator tools in an optimal position during the arrangement of the latter on the expandable shaft.

Furthermore, it is the object of the invention to make a separator unit which allows facilitating the step of arranging separator tools on the expandable shaft.

Again, it is the object of the invention to make a separator unit having reduced sizes with respect to certain types of separator units of the prior art.

These objects are achieved by making a separator unit according to the main claim.

Further features of the separator unit of the invention are described in the dependent claims.

The aforesaid objects are also achieved by the cutting line comprising one or more of the aforesaid separator units of the invention according to claim 11.

Finally, such objects are also achieved by the method of arranging and locking the separator tools on the expandable shaft of a separator unit of the invention.

### BRIEF DESCRIPTION OF THE DRAWINGS

The aforesaid objects, together with the advantages described below, will be noted during the description of a preferred implementation embodiment of the invention, which is given by way of a non-limiting indicative example, with reference to the accompanying drawings, where:

FIG. 1 shows an axonometric view of the separator unit of the invention, with the separator tools located in the storage magazine;

FIG. 2 shows the top view of the separator unit of the invention, with the separator tools located in the storage magazine;

FIG. 3 shows an axonometric view of the separator unit of the invention, with the separator tools located along the expandable shaft;

FIG. 4 shows the top view of the separator unit of the invention, with the separator tools located along the expandable shaft;

FIG. 5 shows a cross-section view, along the section line IV-IV of FIG. 4, of the coupling of the same expandable shaft with a separator tool;

FIGS. 6a and 6b show a cross-section view, along the section lines V′-V′ and V″-V″ of FIG. 5, of the detail of the knurled locking element and of the counter-knurled ring nut respectively in the uncoupled configuration and coupled configuration;

FIG. 7 shows a sectioned axonometric view of the translation means belonging to the separator unit of the invention according to a section plane on which the longitudinal axis X of the expandable shaft lies;

FIG. 8 shows an axonometric view of the retractable punch belonging to the translation means of FIG. 7, according to the preferred implementation embodiment of the invention;

FIG. 9 diagrammatically shows a cutting line comprising the separator unit of the invention.

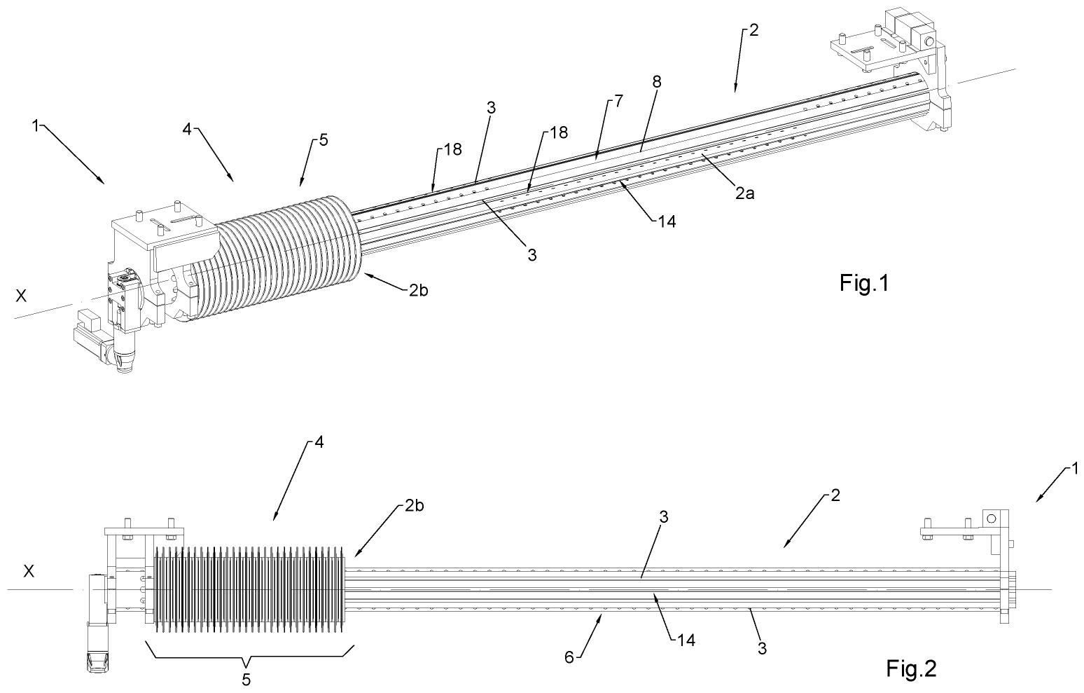

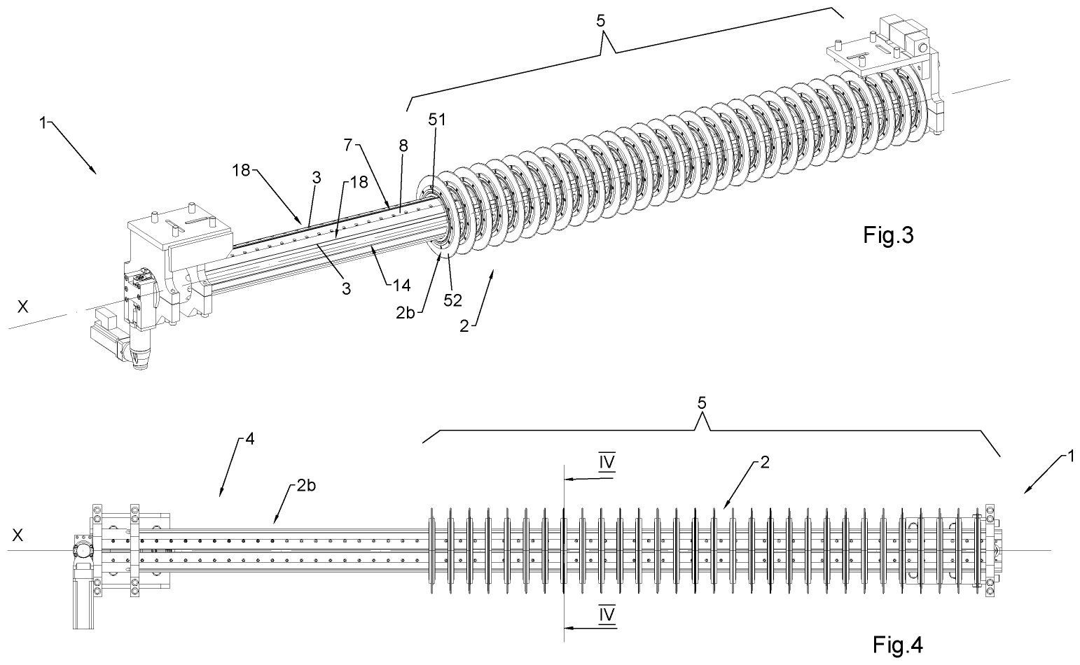

### DETAILED DESCRIPTION OF THE PREFERRED EMBODIMENTS

The separator unit of the invention, which is suitable for being used in a cutting line of laminar materials into strips, is depicted as a whole in figures from 1 to 4, where it is indicated as a whole with 1.

As is shown in the figures, the separator unit 1 comprises an expandable shaft 2, preferably cylindrical in shape, preferably provided with a plurality of expandable means 3 arranged in substantially longitudinal direction along the expandable shaft 2.

As described in the introduction of the prior art, such expandable means 3 known in themselves preferably comprise longitudinal strips with a vulcanized rubber finishing defined on the surface thereof facing outwards, and air chambers arranged between the strips and the shaft 2. Such air chambers preferably are operatively connected to a pneumatic source (not shown in the figures) capable of filling the air chambers with a gas, preferably with air. Thereby, as is known, the expandable means 3 expand, accordingly increasing the diameter of the expandable shaft 2 and locking the separator tools 5 arranged previously along the expandable shaft 2, in predefined positions.

Obviously, such pneumatic source is also configured to allow the emptying of the gas inside the air chambers of the expandable means 3 in expanded configuration when there is a need to extract the separator tools 5 from the expandable shaft 2 or there is a need to modify their arrangement on the shaft 2.

According to implementation variants of the invention, the expandable means 3 alternatively could be operatively connected to a hydraulic source, of the type in itself known, so long as it is capable of expanding the expandable means 3.

Furthermore, according to different implementation embodiments of the invention, the aforesaid expandable means 3 could be of the mechanical type.

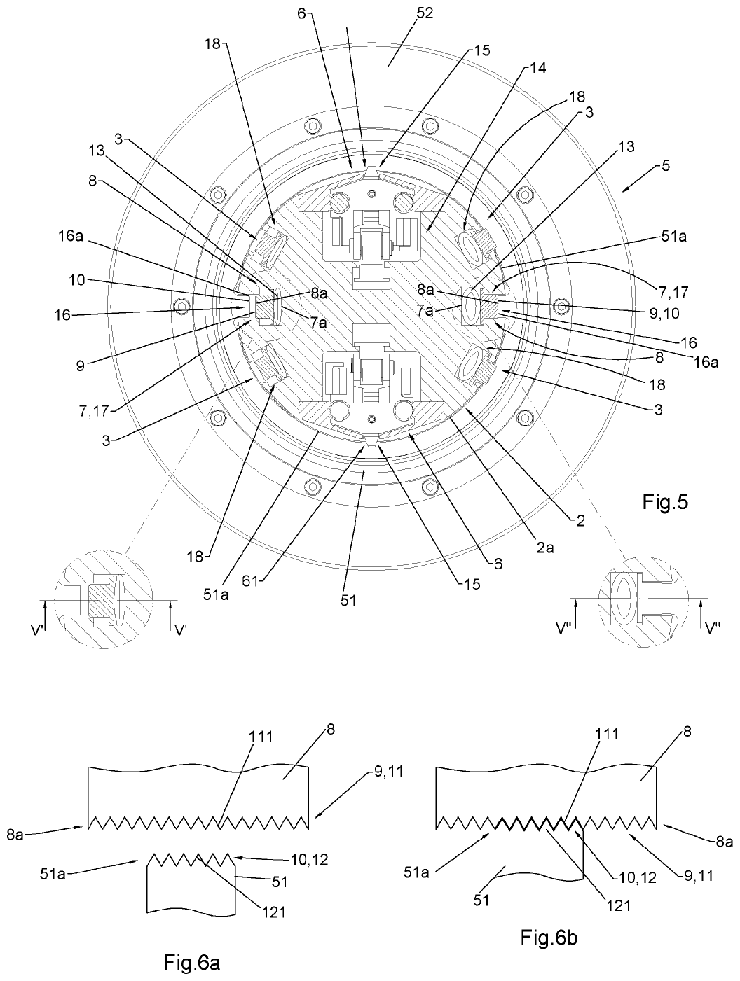

Preferably, such expandable means 3 are arranged along the expandable shaft in specific longitudinal housings 18 which are lowered with respect to the outer surface 2a of the expandable shaft 2, as shown in FIG. 5.

However, it is not excluded for such expandable means 3 to be arranged on the outer surface 2a of the expandable shaft 2 without defining the aforesaid longitudinal housings 18, so long as they allow translating the separator tools 5 on the expandable shaft 2 when they are in their non-expanded configuration and they also prevent the movement of the separator tools 5 when they are in expanded configuration.

Preferably, the expandable shaft 2 is an expandable shaft of the fixed type. According to an alternative implementation embodiment, it is not excluded for the expandable shaft 2 to be rotating.

As shown in the aforesaid figures from 1 to 4, the separator unit 1 of the invention also comprises a storage magazine 4 for storing the aforesaid separator tools 5. For such object, the storage magazine 4 is operatively associated with an end 2b of the expandable shaft 2. Preferably, it is defined and shaped like an extension of the aforesaid expandable shaft 2 at the aforesaid end 2b of the latter.

The separator unit 1 of the invention obviously also comprises a plurality of the aforesaid separator tools 5, each of which is provided with a disc 52, preferably annular in shape, of limited thickness, with which a ring nut 51, preferably an annular ring nut, is centrally and axially associated, which is configured to allow the translation of the separator tool 5 from the storage magazine 4 to the expandable shaft 2 in a predefined position, and vice versa. Such translation can clearly be implemented when the expandable shaft 2 is in non-expanded configuration.

According to the preferred implementation embodiment herein described which provides a fixed expandable shaft 2, the annular disc 52 of each separator tool 5 is connected to the relative annular ring nut 51 by means of a mechanical bearing so that the annular disc 52 can rotate relative to the expandable shaft 2 in operating step.

Alternatively, if the expandable shaft 2 is of the rotating type, the annular disc 52 of each separator tool 5 is fixedly associated with the relative annular ring nut 51 so that the rotation of the expandable shaft 2 results in the rotation of the annular disc 52.

Furthermore, as is described in detail below, the separator unit 1 of the invention comprises translation means 4 configured to operate the aforesaid translation of the separator tools 5.

According to the invention, as shown in FIG. 5, the expandable shaft 2 is provided with at least a first slit 7, preferably with two first slits 7 made in longitudinal direction along the same expandable shaft 2 and in diametrically opposed position between them. Each of the aforesaid first slits 7 is configured to house a locking element 8 having substantially longitudinal development and which has a knurling 9 on its outwards facing surface 8a.

According to the invention, such locking element 8 is susceptible to translating in radial direction with respect to the longitudinal axis X of the expandable shaft 2.

In particular, such radial translation preferably is actuated by interposing an expandable element 13, even more preferably an air chamber operatively communicating with the aforesaid pneumatic source or with a different pneumatic source with respect to the one of the expandable means 3, between the bottom 7a of each of the aforesaid first slits 7 and the relative locking element 8.

According to different implementation embodiments of the invention, it is not excluded for such expandable element 13 to be of other type, for example mechanical, so long as it is capable of radially translating the locking element 8.

According to implementation variants of the invention, the number of the aforesaid first slits 7 and of the relative locking elements 8 may be less or greater than two.

Symmetrically, according to the invention, the ring nuts 51 of the aforesaid separator tools 5 have a counter-knurling 10 at one or more lengths, preferably at two lengths defined diametrically opposed to each other, of their surface 51a facing the expandable shaft 2.

The invention provides for the knurling 9 made on each of the two locking elements 8 to be configured to fixedly couple with one of the two counter-knurlings 10 made on the aforesaid surface 51a of each of the ring nuts 51 of the separator tools 5 when the surfaces 8a of the locking elements 8 are placed in contact with the relative surfaces 51a of the ring nuts 51, as schematically depicted in FIG. 6b.

Obviously, according to the implementation variants of the invention which provide a different number of locking elements 8 with respect to the one of the preferred implementation embodiment, there must be provided the same number of lengths with such counter-knurling 10 made on the aforesaid surfaces 51a of the ring nuts 51 and adapted to allow the aforesaid coupling with the relative knurling s 9.

However, it is not excluded for the aforesaid counter-knurling 10 to be made along the whole surface 51a.

Advantageously, the coupling between each knurling 9 and a relative counter-knurling 10 allows ensuring an optimal locking between the expandable shaft 2 and the separator tools 5 arranged on the shaft 2 when it is in expanded configuration.

With regard to the knurling 9 and the counter-knurling 10, as depicted in FIGS. 6a and 6b, they preferably comprise respectively a toothing 11 and a counter-toothing 12 that are complementary to each other.

Even more preferably, the teeth 111 and 121 of the aforesaid toothing 11 and of the aforesaid counter-toothing 12 are defined in sequence according to a parallel direction with respect to the longitudinal axis X of the expandable shaft 2, as shown in FIGS. 6a and 6b.

Advantageously, such particular configuration allows improving the axial locking between each separator tool 5 and the expandable shaft 2.

Alternatively, according to a different implementation embodiment of the invention, the teeth 111 and 121 of the toothing 11 and of the counter-toothing 12 are defined in sequence according to an orthogonal direction with respect to the longitudinal axis X of the expandable shaft 2.

Advantageously, here the coupling between toothing 11 and counter-toothing 12 improves the rotational locking between each separator tool 5 and the aforesaid expandable shaft 2.

It is not excluded for different implementation embodiments of the invention to provide a knurling 9 and a counter-knurling 10 of different type with respect to the toothing 11 and the counter-toothing 12, so long as their coupling allows fixedly locking each separator tool 5 to the expandable shaft 2.

For example, such knurling 9 and counter-knurling 10 could be made in the shape of side-by-side diamond tips.

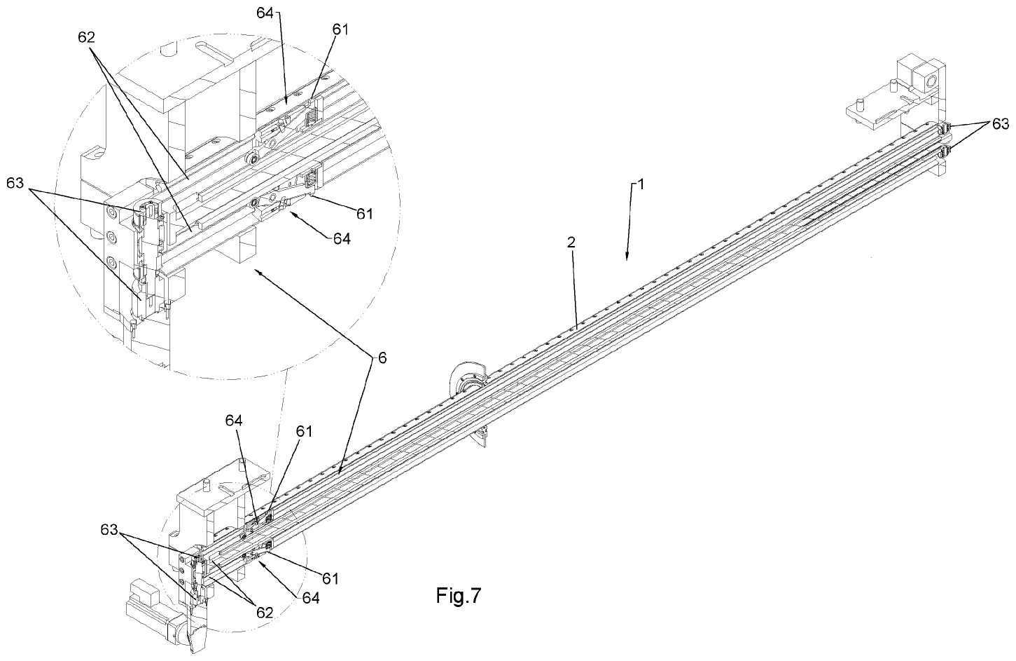

With regard to the aforesaid translation means 6, as shown in FIG. 7, they preferably are made integrated in the expandable shaft 2. In particular, such translation means 6 comprise at least one retractable punch 61, preferably two retractable punches 61, arranged in diametrically opposed positions from each other on the expandable shaft 2. Such retractable punches 61 are susceptible to being translated in radial direction from a first position, according to which they are at least partially exposed with respect to the outer surface 2a of the expandable shaft 2, to a second position, according to which the retractable punches 61 are completely retracted with respect to the aforesaid outer surface 2a. Obviously, such translation must occur also in opposite direction.

Furthermore, according to the invention, the retractable punches 61 are susceptible to translating axially along the expandable shaft 2 through two second slits 14 defined along the expandable shaft 2 and along the storage magazine 4, so as to allow the picking of a separator tool 5 from the storage magazine 4 and its positioning along the expandable shaft 2, as shown in detail below.

In detail, preferably, such axial translation of each of the two retractable punches 61 is implemented with a belt 62 and pulley 63 transmission system inserted in the expandable shaft 2, as shown in FIG. 7. Even more accurately, each of the aforesaid retractable punches 61 is operatively associated with a mechanical slide 64 fixed in a point of the aforesaid belt 62.

With regard to the radial translation of the retractable punch 61, it is implemented by means of mechanical connection members—in themselves known—between the retractable punch 61 and the relative slide 64.

According to implementation variants, it is not excluded for the number of retractable punches 61 on the expandable shaft 2 to be other than two, to be arranged in different positions from the ones described above, or for the axial and radial translation system of the retractable punches 61 to be of alternative type with respect to the one of the preferred implementation embodiment, so long as capable of operating such translations.

Jointly to the presence of the aforesaid retractable punches 61, the separator unit 1 of the invention provides for the annular ring nuts 51 of the separator tools 5 to have, on their surfaces 51a, at least one housing 15, preferably two housings 15 made in diametrically opposed positions from each other, which are configured to house the retractable punches 61 in their first position.

Obviously, the number and the position of the housings 15 defined on the ring nuts 51 of the separator tools 5 must correspond with the number and positions of the retractable punches 61 located on the expandable shaft 2.

However, it is not excluded that there may alternatively be provided a single housing 15 that extends for the whole surface 51a of the annular ring nuts 51.

As mentioned above, the aforesaid translation means 6 are configured to axially translate the retractable punches 61 at one of the separator tools 5, position the retractable punches 61 in their first position, thus coupling with the housings 15 of the ring nut 51 of the aforesaid separator tool 5, and translate the retractable punches 61 jointly with the separator tool 5 from the storage magazine 4 to a predefined position on the expandable shaft 2. Clearly, the translation means 6 are configured to also execute the inverse translation operation.

Preferably, both the free end 61a of each retractable punch 61 and the housings 15 are shaped in the form of a frusto pyramid with radial axis of development with respect to the expandable shaft 2, and are complementary to each other.

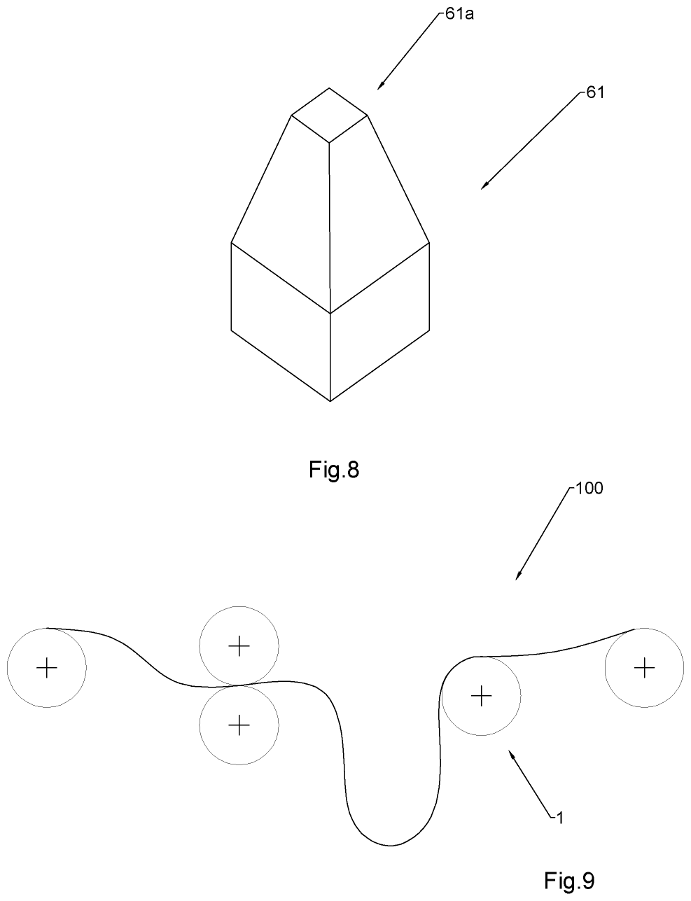

A depiction of the aforesaid configuration is shown in FIG. 8 with regard to the retractable punch 61.

Advantageously, such characteristic allows achieving the two advantages disclosed below.

Mainly, the aforesaid shaping of the retractable punches 61 and of the housings 15, jointly with the fact that the two retractable punches 61 are defined in diametrically opposed positions from each other, allows the raising and moving away of the separator tool 5 from the expandable shaft 2 in the release step of the retractable punches 61 and the coupling step thereof with the housings 15.

Advantageously, this reduces or even eliminates the possibility of contact, and therefore of friction, between the two during the translation step of the separator tool 5 on the expandable shaft 2.

Secondly, the frusto-pyramidal form of the retractable punches 61 and of the corresponding housings 15 allows ensuring the perfectly orthogonal positioning of the separator tools 5 with respect to the expandable shaft 2 because the coupling between the corresponding surfaces of the frusto pyramids of the retractable punches 61 and of the relative housings 15 acts as centring system.

However, it is not excluded, according to different implementation embodiments of the invention, for the retractable punches 61, and obviously the housings 15, to have different shapes.

For example, according to one implementation variant of the invention, the free end 61a of the retractable punches 61 and the housings 15 could be shaped like a truncated cone with radial axis of development with respect to the expandable shaft 2. Such implementation embodiment allows achieving the aforesaid first advantage, but not also the second.

Incidentally, it is important to note that the solution providing the combination of the retractable punches 61 and the relative housings 15 with the frusto-pyramidal or truncated-conical end proposed above could in itself be the object of claim without the need for such solution to be implemented in a separator unit 1 according to the preferred implementation embodiment of the invention or according to the alternative implementation embodiments described above. Indeed, such last combination of characteristics in itself allows the advantages disclosed above to be achieved.

Preferably, the separator unit 1 of the invention provides for the ring nuts 51 to comprise at least one centring element 16, preferably two centring elements 16 radially protruding from their surface 51a facing the expandable shaft 2. The two centring elements 16 preferably are defined in diametrically opposed positions from each other.

Symmetrically, also the expandable shaft 2 comprises at least a third slit 17, preferably two third slits 17 defined in diametrically opposed positions from each other, having substantially longitudinal development, which are suitable for housing such centring element 16 so as to advantageously prevent the rotation of the separator tools 5 with respect to the expandable shaft 2.

According to the preferred implementation embodiment herein described and depicted in FIG. 5, the aforesaid third slits 17 correspond to the aforesaid first slits 7 in which there is arranged the locking element 8 and accordingly the counter-knurling 10 of the ring nuts 51 is defined on the surface 16a facing the expandable shaft 2 of the aforesaid centring elements 16.

Such configuration of the invention allows conveying more functionality to the structural elements.

However, it is not excluded for such third slits 17 and such centring elements 16 to be made respectively on the expandable shaft 2 and on the ring nuts 51 in separate angular positions from the aforesaid first slits 7/locking elements 8 and relative lengths in which the aforesaid counter-knurling 10 is obtained.

Furthermore, according to an alternative implementation embodiment of the invention, it is not excluded for there not to be such centring elements 16 and the relative slits 17.

Incidentally, it is important to note that the solution providing the combination of the centring elements 16 and the third slits 17 proposed above could in itself be the object of claim without the need for such solution to be implemented in a separator unit 1 according to the preferred implementation embodiment of the invention or according to the alternative implementation embodiments described above. Indeed, such last combination of characteristics in itself allows the advantages disclosed above to be achieved.

As mentioned above, also the cutting line 100 of the laminar materials into strips, wound on bobbins, in particular of sheets of different thicknesses, widths and lengths, schematically depicted in FIG. 9, is part of the invention.

According to the invention, such cutting line 100 comprises one or more separator units 1 which characteristics were described above.

Furthermore, also the method of arranging and locking a plurality of separator tools 5 along an expandable shaft 2 belonging to the separator unit 1 of the invention is part of the invention.

In particular, the method of the invention provides axially translating the retractable punches 61 at one of the separator tools 5 located in the storage magazine 4.

Obviously, such axial translation must occur when the retractable punch 61 is arranged in its aforesaid retracted second position.

Then the method provides extracting the retractable punches 61 from the expandable shaft 2 so as to obtain the coupling with the housings 15 of the ring nut 51 of the aforesaid separator tool 5.

The method then provides for translating the retractable punches 61 jointly with the separator tool 5 along the expandable shaft 2 at a predefined position.

The separator tool 5 being located in such predefined position, the retractable punches 61 are retracted and the aforesaid steps are possibly repeated for further one or more separator tools 5.

When all the separator tools 5 are arranged in the corresponding predefined positions, the method provides expanding the expandable means 3 and the expandable elements 13 so that the first ones come in contact directly with the surface 51a of the aforesaid ring nuts 51, while the second ones allow the locking elements 8 to radially translate outwards up to reaching the stable coupling between the toothings 11 and the relative counter-toothings 12.

According to an alternative implementation embodiment, it is not excluded for the method to provide the expansion of the expandable elements 13 alone.

Due to that mentioned hereto, it is understood that the separator unit described above achieves the preset objects.

In particular, the object is achieved of making a separator unit which, once provided, is capable of ensuring increased stability of its composition with respect to the separator units of the prior art.

In greater detail, the object of the invention of making a separator unit capable of improving locking the separator tools on the expandable shaft is achieved.

Furthermore, the object is achieved of making a separator unit capable of keeping the aforesaid separator tools in an optimal position during the arrangement of the latter on the expandable shaft.

Likewise, the object is achieved of making a separator unit which allows facilitating the step of arranging separator tools on the expandable shaft.

Finally, the object is achieved of making a separator unit having reduced sizes with respect to certain types of separator units of the prior art.

1. A separator unit suitable for being used in a cutting line of laminar materials into strips, of the type comprising:
an expandable shaft preferably provided with one or more expandable means arranged in substantially longitudinal direction along said expandable shaft;
a storage magazine for storing separator tools, which is operatively associated with an end of said expandable shaft;
said separator tools provided with ring nuts configured to allow the translation of said separator tools from said storage magazine to said expandable shaft in predefined positions, and vice versa when said expandable shaft is in non-expanded configuration, said separator tools also being susceptible to being locked in said predefined positions when said expandable shaft is in expanded configuration;
translation means configured to translate said separator tools from said storage magazine to said expandable shaft, and vice versa;
wherein:
said expandable shaft is provided with at least a first slit made in longitudinal direction, said first slit housing a locking element with substantially longitudinal development, said locking element having a knurling on its outwards facing surface and being susceptible to translating in radial direction with respect to the longitudinal axis (X) of said expandable shaft;
said ring nuts have a counter-knurling on one or more lengths of their surfaces facing said expandable shaft;
said knurling and said counter-knurling being configured to fixedly couple when said surface of said locking element is placed in contact with said surfaces of said ring nuts.

2. The separator unit according to claim 1, wherein said knurling and said counter-knurling comprise respectively a toothing and a counter-toothing which are complementary to each other.

3. The separator unit according to claim 2, wherein the teeth of said toothing and of said counter-toothing are defined in sequence according to a parallel direction with respect to said longitudinal axis (X) of said expandable shaft.

4. The separator unit according to claim 2, wherein the teeth of said toothing and of said counter-toothing are defined in sequence according to an orthogonal direction with respect to said longitudinal axis (X) of said expandable shaft.

5. The separator unit according to claim 1, further comprising an expandable element interposed between the bottom of said first slit and said locking element, said expandable element being configured to translate said locking element according to said radial direction.

6. The separator unit according to claim 1, wherein said expandable shaft provides two of said first slits defined in diametrically opposed positions, each of said first slits housing said locking element.

7. The separator unit according to claim 1, wherein:
said translation means are integrated in said expandable shaft, said translation means comprising at least one retractable punch susceptible to being translated in radial direction from a first position according to which said retractable punch is at least partially exposed with respect to the outer surface of said expandable shaft to a second position according to which said retractable punch is completely retracted with respect to said outer surface of said expandable shaft, and vice versa, said retractable punch also being susceptible to translating axially along said expandable shaft through a second slit made in said expandable shaft and along said storage magazine;
said ring nuts have, on their surfaces (51a) facing said expandable shaft, at least one housing configured to house said retractable punch in said first position;
said translation means being configured to axially translate said retractable punch at one of said separator tools, to position said retractable punch in said first position to couple with one of said housings of said ring nut of said separator tool and to translate said retractable punch jointly with said separator tool from said storage magazine to a predefined position on said expandable shaft, and vice versa.

8. The separator unit according to claim 7, wherein said translation means comprise two retractable punches arranged at two second slits defined in said expandable shaft in diametrically opposed positions.

9. The separator unit according to claim 7, wherein the free end of said at least one retractable punch and said housings are shaped in the form of a frusto pyramid with radial axis of development with respect to said expandable shaft.

10. The separator unit according to claim 1, wherein:
said ring nuts have at least one centring element radially projecting from said surface facing said expandable shaft;
said expandable shaft has at least a third slit with substantially longitudinal development adapted to house said centring element so as to prevent the rotation of said separator tools with respect to said expandable shaft.

11. A cutting line of laminar materials into strips, wound on bobbins, in particular of sheets of different thicknesses, widths and lengths, comprising one or more separator units according to claim 1.
